(19) United States
(12) Patent Application Publication
(10) Pub. No.: US 2023/0051963 A1
(43) Pub. Date: Feb. 16, 2023

(54) INFORMATION PROCESSING APPARATUS, INFORMATION PROCESSING METHOD, AND INFORMATION PROCESSING PROGRAM

(71) Applicant: FUJIFILM CORPORATION, Tokyo (JP)

(72) Inventors: Yutaka OISHI, Tokyo (JP); Michitaka KONDO, Tokyo (JP); Misaki OTSUKA, Tokyo (JP); Yuko MASUDA, Tokyo (JP)

(21) Appl. No.: 17/813,326

(22) Filed: Jul. 18, 2022

(30) Foreign Application Priority Data
Aug. 12, 2021 (JP) 2021-131795

(51) Int. Cl. G06F 3/06

(52) U.S. Cl. CPC G06F 3/0649; G06F 3/0607; G06F 3/0686

(57) ABSTRACT

An information processing apparatus selects a magnetic tape as a data migration target from among a plurality of migration-source magnetic tapes based on an index value correlated with a read frequency of valid data recorded in the magnetic tape, the index value being calculated for each of the magnetic tapes, specifies valid data recorded in the selected magnetic tape, and performs control of migrating the valid data to a migration-destination magnetic tape.

### CROSS-REFERENCE TO RELATED APPLICATIONS

The present application claims priority under 35 U.S.C. § 119 to Japanese Patent Application No. 2021-131795 filed on Aug. 12, 2021. The above application is hereby expressly incorporated by reference, in its entirety, into the present application.

### BACKGROUND

### 1. Technical Field

The present disclosure relates to an information processing apparatus, an information processing method, and an information processing program.

### 2. Description of the Related Art

JP2017-049897A discloses a technique for performing processing of migrating valid data of a magnetic tape to another magnetic tape (hereinafter, referred to as “reclamation processing”) in a case where invalid data of the magnetic tape increases. In the technique, an area in which data can be recorded can be increased by initializing a migration-source magnetic tape or replacing a migration-source magnetic tape with a new magnetic tape.

### SUMMARY

An object of the present disclosure is to provide an information processing apparatus, an information processing method, and an information processing program capable of shortening a data read time from a magnetic tape after reclamation processing.

According to an aspect of the present disclosure, there is provided an information processing apparatus including: at least one processor, in which the processor is configured to select a magnetic tape as a data migration target from among a plurality of migration-source magnetic tapes based on an index value correlated with a read frequency of valid data recorded in the magnetic tape, the index value being calculated for each of the magnetic tapes, and specify valid data recorded in the selected magnetic tape and perform control of migrating the valid data to a migration-destination magnetic tape.

In the information processing apparatus according to the aspect of the present disclosure, the processor may be configured to select, as the migration target, a magnetic tape of which the index value is equal to or larger than a threshold value or a magnetic tape of which the index value is relatively large.

Further, in the information processing apparatus according to the aspect of the present disclosure, the processor may be configured to select, as the migration target, a magnetic tape of which the index value is smaller than a second threshold value or a magnetic tape of which the index value is relatively small in a case where a value indicating a probability that data migration processing is to be interrupted is equal to or larger than a first threshold value.

Further, in the information processing apparatus according to the aspect of the present disclosure, the processor may be configured to perform control of migrating, among pieces of valid data and invalid data recorded in the selected magnetic tape, only the valid data to a migration-destination magnetic tape.

Further, in the information processing apparatus according to the aspect of the present disclosure, the processor may be configured to further select a magnetic tape as the migration target based on an index value correlated with an amount of the valid data or an index value correlated with an amount of the invalid data.

Further, in the information processing apparatus according to the aspect of the present disclosure, the processor may be configured to further select a magnetic tape as the migration target based on a deletion deadline of the invalid data.

Further, in the information processing apparatus according to the aspect of the present disclosure, the processor may be configured to further select a magnetic tape as the migration target based on an index value correlated with a data write frequency of each of the plurality of migration-source magnetic tapes.

Further, according to another aspect of the present disclosure, there is provided an information processing method executed by a processor of an information processing apparatus, the method including: selecting a magnetic tape as a data migration target from among a plurality of migration-source magnetic tapes based on an index value correlated with a read frequency of valid data recorded in the magnetic tape, the index value being calculated for each of the magnetic tapes; and specifying valid data recorded in the selected magnetic tape and performing control of migrating the valid data to a migration-destination magnetic tape.

Further, according to still another aspect of the present disclosure, there is provided an information processing program causing a processor of an information processing apparatus to execute a process comprising: selecting a magnetic tape as a data migration target from among a plurality of migration-source magnetic tapes based on an index value correlated with a read frequency of valid data recorded in the magnetic tape, the index value being calculated for each of the magnetic tapes; and specifying valid data recorded in the selected magnetic tape and performing control of migrating the valid data to a migration-destination magnetic tape.

According to the present disclosure, it is possible to shorten a data read time from a magnetic tape after reclamation processing.

### BRIEF DESCRIPTION OF THE DRAWINGS

FIG. 1 is a block diagram illustrating an example of a configuration of an information processing system.

FIG. 2 is a block diagram illustrating an example of a hardware configuration of an information processing apparatus.

FIG. 3 is a diagram illustrating an example of a tape management table.

FIG. 4 is a diagram for explaining invalid data.

FIG. 5 is a diagram for explaining processing of migrating only valid data.

FIG. 6 is a block diagram illustrating an example of a functional configuration of the information processing apparatus.

FIG. 7 is a flowchart illustrating an example of data migration processing.

FIG. 8 is a diagram for explaining a result of data migration processing.

### DETAILED DESCRIPTION

Hereinafter, an example of an embodiment for performing a technique according to the present disclosure will be described in detail with reference to the drawings.

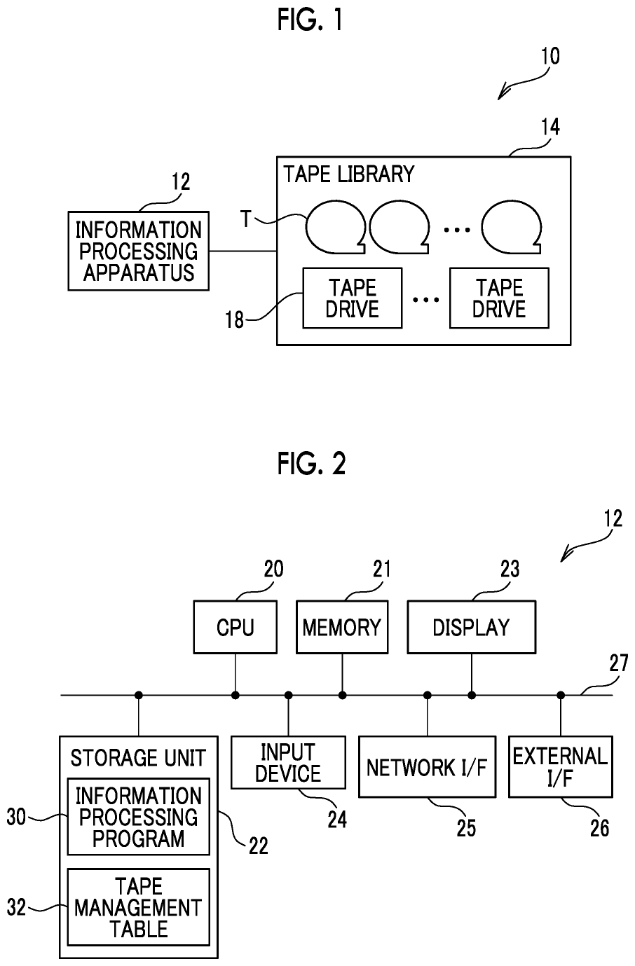

First, a configuration of an information processing system 10 according to the present embodiment will be described with reference to FIG. 1. As illustrated in FIG. 1, the information processing system 10 includes an information processing apparatus 12 and a tape library 14. Examples of the information processing apparatus 12 include a server computer and the like.

The tape library 14 includes a plurality of slots (not illustrated) and a plurality of tape drives 18, and each slot includes a magnetic tape T as an example of a recording medium. Each tape drive 18 is connected to the information processing apparatus 12. The tape drive 18 writes or reads data to or from the magnetic tape T under a control of the information processing apparatus 12. Examples of the magnetic tape T include a linear tape-open (LTO) tape.

In a case where the information processing apparatus 12 writes or reads data to or from the magnetic tape T, the magnetic tape T as a write target or a read target is loaded from the slot into a predetermined tape drive 18. In a case where data is written or read to and from the magnetic tape T loaded into the tape drive 18, the magnetic tape T is unloaded from the tape drive 18 into the slot in which the magnetic tape T is originally included.

Next, a hardware configuration of the information processing apparatus 12 according to the present embodiment will be described with reference to FIG. 2. As illustrated in FIG. 2, the information processing apparatus 12 includes a central processing unit (CPU) 20, a memory 21 as a temporary memory area, and a non-volatile storage unit 22. Further, the information processing apparatus 12 includes a display 23 such as a liquid crystal display, an input device 24 such as a keyboard and a mouse, a network interface (I/F) 25 connected to a network, and an external I/F 26 to which each tape drive 18 is connected. The CPU 20, the memory 21, the storage unit 22, the display 23, the input device 24, the network I/F 25, and the external I/F 26 are connected to a bus 27.

The storage unit 22 is realized by a hard disk drive (HDD), a solid state drive (SSD), a flash memory, or the like. An information processing program 30 is stored in the storage unit 22 as a storage medium. The CPU 20 reads the information processing program 30 from the storage unit 22, develops the read information processing program 30 in the memory 21, and executes the developed information processing program 30.

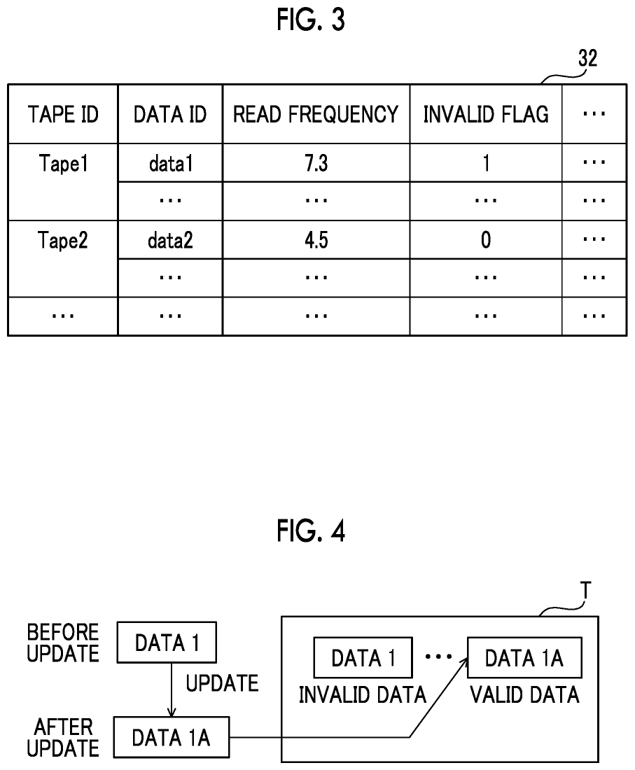

Further, the storage unit 22 stores a tape management table 32 for managing the magnetic tape T. FIG. 3 illustrates an example of the tape management table 32. As illustrated in FIG. 3, the tape management table 32 includes a tape identifier (ID) which is an example of identification information of the magnetic tape T and a data ID which is an example of identification information of the data recorded in the magnetic tape T. Further, in the tape management table 32, the data ID is associated with a read frequency of data indicated by the data ID and an invalid flag.

In a read frequency column of the tape management table 32, for example, the number of times of read per unit time (for example, one hour) in a latest predetermined period (for example, one day) is stored. The information recorded in the read frequency column may be an index value which is correlated with a read frequency such as the cumulative number of times of read of data.

In an invalid flag column of the tape management table 32, information indicating whether the data is invalid data or valid data is stored. In the present embodiment, in a case where the data is invalid data, “1” is stored in the invalid flag column, and in a case where the data is valid data, “0” is stored in the invalid flag column. That is, the information processing apparatus 12 can specify whether the data recorded in the magnetic tape T is valid data or invalid data by referring to the invalid flag column of the tape management table 32.

The invalid data is, for example, data for which a deletion instruction is input by the user and which is logically deleted. In order to physically delete the data for which the deletion instruction is input by the user from the magnetic tape T, all pieces of data recorded in the magnetic tape T are temporarily saved in another storage area, the magnetic tape T is initialized, and pieces of data excluding the logically-deleted data among all pieces of the saved data are recorded in the magnetic tape T. For this reason, in order to physically delete the data from the magnetic tape T, the tape drive 18 is occupied for a relatively long time. Therefore, in the present embodiment, the data for which the deletion instruction is input by the user is logically deleted by storing “1” in the invalid flag column of the tape management table 32. Thereby, the data will not be accessed by the user.

Further, as an example, as illustrated in FIG. 4, in the present embodiment, data updated by the user is not overwritten in the magnetic tape T, but the updated data is newly recorded in the magnetic tape T. In this case, the data before update that is recorded in the magnetic tape T will not be accessed by the user. Therefore, the invalid data may be the data before update that is no longer accessed by the user due to update. In addition, the invalid data may be both logically-deleted data and data before update. Further, the valid data means data other than the invalid data, that is, data that may be accessed by the user.

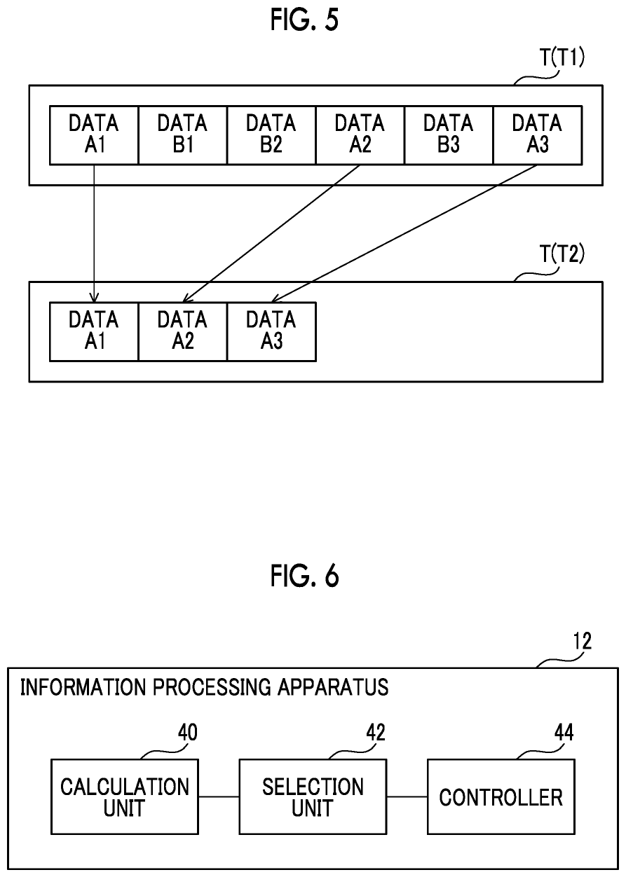

In addition, as illustrated in FIG. 5, as an example, among the valid data and invalid data recorded in the migration-source magnetic tape T, only the valid data is migrated to a migration-destination magnetic tape T, and a free capacity can be increased by initializing the migration-source magnetic tape T or replacing the migration-source magnetic tape T with a new magnetic tape T. FIG. 5 illustrates an example in which pieces of data A1 to A3 are valid data and pieces of data B1 to B3 are invalid data. In the following, a magnetic tape T as a data migration source is referred to as a “magnetic tape T1”, and a magnetic tape T as a data migration destination is referred to as a “magnetic tape T2”. Further, in the following, processing of migrating, to the magnetic tape T2, only the valid data among the valid data and the invalid data recorded in the magnetic tape T1 is referred to as “reclamation processing”. In the present embodiment, a case where the magnetic tape T1 and the magnetic tape T2 are different magnetic tapes is described. On the other hand, the magnetic tape T1 and the magnetic tape T2 may be the same magnetic tape.

The information processing apparatus 12 according to the present embodiment sets, as a target of reclamation processing, the magnetic tape T1 in which a ratio of the invalid data is equal to or higher than a certain value or the magnetic tape T1 in which a total value of sizes of pieces of the invalid data is equal to or larger than a certain value. The information processing apparatus 12 has a function of selecting the magnetic tape T1 on which reclamation processing is to be preferentially performed in a case where there are a plurality of magnetic tapes T1 on which reclamation processing is to be performed. In the following, the migration-source magnetic tape T1 in the reclamation processing is referred to as a “processing target magnetic tape”.

Next, a functional configuration of the information processing apparatus 12 according to the present embodiment will be described with reference to FIG. 6. As illustrated in FIG. 6, the information processing apparatus 12 includes a calculation unit 40, a selection unit 42, and a controller 44. In a case where the CPU 20 executes the information processing program 30, the information processing apparatus 12 functions as the calculation unit 40, the selection unit 42, and the controller 44.

The calculation unit 40 calculates an index value V1 correlated with the read frequency of the valid data recorded in the processing target magnetic tape, the index value V1 being an index value calculated for each processing target magnetic tape. Specifically, the calculation unit 40 calculates, as the index value V1, the number of pieces of the valid data of which the read frequency is equal to or higher than a threshold value TH1 for each processing target magnetic tape by referring to the tape management table 32. The calculation unit 40 may calculate, as the index value V1, a total value of sizes of pieces of the valid data of which the read frequency is equal to or higher than the threshold value TH1. Further, the calculation unit 40 may calculate, as the index value V1, a ratio of the number or the total value of the sizes of pieces of the valid data, of which the read frequency is equal to or higher than the threshold value TH1, to the number or the total value of the sizes of all pieces of the valid data recorded in the processing target magnetic tape.

The selection unit 42 selects the magnetic tape T1 as a data migration target from among the plurality of processing target magnetic tapes based on the index value V1 calculated by the calculation unit 40. Specifically, the selection unit 42 selects, as a migration target, the magnetic tape T1 of which the index value V1 is equal to or larger than a threshold value TH2. The selection unit 42 may select, as a migration target, the magnetic tape T1 having a relatively large index value V1. In this case, for example, the selection unit 42 selects a predetermined number of the magnetic tapes T1 in order from the magnetic tape having a largest index value V1. The number of the magnetic tapes T1 selected by the selection unit 42 is set, for example, to be equal to or smaller than the number of the tape drives 18 included in the tape library 14. Further, the number of the magnetic tapes T1 selected by the selection unit 42 may be preset as a fixed value, or the number of unused tape drives 18 may be set at a timing when the selection unit 42 selects the magnetic tapes T1. Further, the threshold values TH1 and TH2 are set in advance based on a characteristic of the system or a manual setting by the user.

The controller 44 performs control of migrating, to the migration-destination magnetic tape T2, only the valid data among pieces of the valid data and the invalid data recorded in the magnetic tape T1 selected by the selection unit 42. Specifically, the controller 44 performs control of reading all pieces of data recorded in the magnetic tape T1 selected by the selection unit 42. Next, the controller 44 performs control of recording, in the magnetic tape T2, the valid data among all pieces of data obtained by the control by referring to the tape management table 32, and discards the invalid data. In the present embodiment, as the magnetic tape T2, for example, a magnetic tape T in which data is not recorded, such as an unused magnetic tape T or a magnetic tape T immediately after initialization, is used.

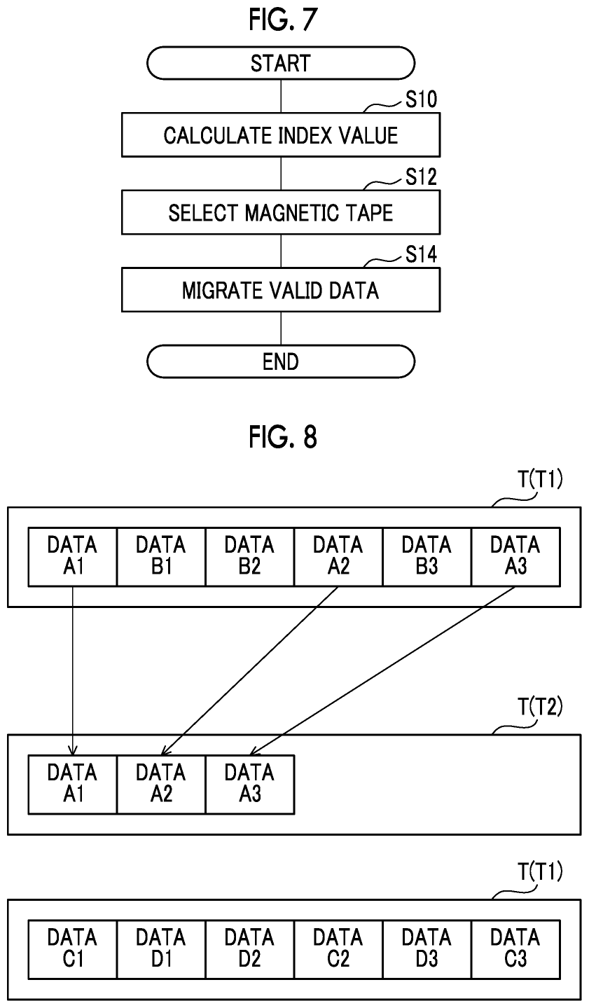

Next, an operation of the information processing apparatus 12 according to the present embodiment will be described with reference to FIG. 7. In a case where the CPU 20 executes the information processing program 30, data migration processing illustrated in FIG. 7 is executed. The data migration processing illustrated in FIG. 7 is executed, for example, in a case where a data migration instruction is input by the user or in a case where the number of the processing target magnetic tapes is equal to or larger than a certain number.

In step S10 of FIG. 7, as described above, the calculation unit 40 calculates an index value V1 correlated with the read frequency of the valid data recorded in the processing target magnetic tape, the index value V1 being an index value calculated for each processing target magnetic tape. In step S12, as described above, the selection unit 42 selects the magnetic tape T1 as a data migration target from among the plurality of processing target magnetic tapes based on the index value V1 calculated in step S10.

In step S14, as described above, the controller 44 performs control of migrating, to the migration-destination magnetic tape T2, only the valid data among pieces of the valid data and the invalid data recorded in the magnetic tape T1 selected in step S12. In a case where the processing of step S14 is completed, data migration processing is completed. The controller 44 may perform control of initializing the magnetic tape T1 selected in step S12 after the data migration processing is completed. In this case, the initialized magnetic tape T1 can be reused. Further, the controller 44 may perform control of unloading the magnetic tape T1 selected in step S12 from the tape library 14 after the data migration processing is completed. In this case, a new magnetic tape T can be included in the tape library 14 instead of the unloaded magnetic tape T1.

As described above, according to the present embodiment, as illustrated in FIG. 8, as an example, in a case where there are a plurality (two in the example of FIG. 8) of processing target magnetic tapes, the magnetic tape T1 on which reclamation processing is to be preferentially executed is determined based on the index value V1. FIG. 8 illustrates an example in which pieces of data A1 to A3 and data C1 to C3 are valid data and pieces of data B1 to B3 and data D1 to D3 are invalid data. Further, FIG. 8 illustrates an example in which the read frequencies of pieces of data A1 to A3 are equal to or higher than the threshold value TH1 and the read frequencies of pieces of the data C1 to C3 are lower than the threshold value TH1. That is, in the example of FIG. 8, the upper magnetic tape T1 has an index value V1 equal to or larger than the threshold value TH2, and the lower magnetic tape T1 has an index value V1 smaller than the threshold value TH2. Therefore, in the example of FIG. 8, first, reclamation processing is executed on the upper magnetic tape T1, and then reclamation processing is executed on the lower magnetic tape T1.

As described above, in the present embodiment, reclamation processing is preferentially executed from the magnetic tape T1 in which a relatively large amount of valid data having a relatively high read frequency is recorded. The data having a relatively high read frequency is also relatively likely to be read together in single read processing. Such data is recorded at a closer position on the magnetic tape T2 by reclamation processing at an earlier stage. As a result, it is possible to shorten a data read time from the magnetic tape T2 after the reclamation processing.

In the embodiment, a case where the selection unit 42 selects, as a migration target, the magnetic tape T1 of which the index value V1 is equal to or larger than the threshold value TH2 has been described. On the other hand, the present disclosure is not limited thereto. For example, in a case where a value indicating a probability that data migration processing is to be interrupted is equal to or larger than a threshold value TH3, the selection unit 42 may select, as a migration target, the magnetic tape T1 of which the index value V1 is smaller than the threshold value TH2. Further, in this case, the selection unit 42 may select, as a migration target, the magnetic tape T1 having a relatively small index value V1. In this case, for example, the selection unit 42 selects a predetermined number of the magnetic tapes T1 in order from the magnetic tape having a smallest index value V1.

For example, in a case where a priority of the data read processing from the magnetic tape T based on an access from the user is higher than a priority of the data read processing from the magnetic tape T based on reclamation processing, in a time period for which there are relatively many accesses from users, there is a relatively high probability that data migration processing is to be interrupted. Therefore, for example, the selection unit 42 uses an access frequency from the user, as a value indicating a probability that data migration processing is to be interrupted. That is, in a time period for which the access frequency from the user is higher, the value indicating the probability that data migration processing is to be interrupted is also larger.

In a case where data migration processing in reclamation processing is interrupted, the valid data is dispersed between the migration-source magnetic tape T1 and the migration-destination magnetic tape T2. In this case, in a case where the valid data is data having a relatively high read frequency, in order to read the valid data, the valid data will be read from the two magnetic tapes T1 and T2. As a result, a data read time is increased. Therefore, as described above, in a case where there is a relatively high probability that data migration processing is to be interrupted, the magnetic tape T1 in which the valid data having a relatively low read frequency is recorded may be set as a migration target.

Further, in the embodiment, the calculation unit 40 may further calculate an index value V2 correlated with an amount of the valid data or an index value V3 correlated with an amount of the invalid data, for each processing target magnetic tape. Examples of the index value V2 include the number of pieces of the valid data, a total value of sizes of pieces of the valid data, and the like. Further, examples of the index value V3 include the number of pieces of the invalid data, a total value of sizes of pieces of the invalid data, and the like.

In this case, for example, in a case where there are a plurality of magnetic tapes T1 of which the index values V1 are equal to or larger than the threshold value TH2 and a difference between the index values V1 of the plurality of magnetic tapes T1 is within a certain range, the selection unit 42 selects the magnetic tape T1 as a data migration target from among the plurality of magnetic tapes T1 based on the index value V2 or the index value V3. Specifically, for example, the selection unit 42 selects, as a migration target, the magnetic tape T1 having a smallest index value V2 or the magnetic tape T1 having a largest index value V3. Thereby, the magnetic tape T1 that can secure more free capacity by the reclamation processing is preferentially selected.

Further, in the embodiment, the selection unit 42 may select the magnetic tape T1 as a data migration target based on a deletion deadline of the invalid data in addition to the index value V1. For example, in a case where there are a plurality of magnetic tapes T1 of which the index values V1 are equal to or larger than the threshold value TH2 and a difference between the index values V1 of the plurality of magnetic tapes T1 is within a certain range, the selection unit 42 selects the magnetic tape T1 as a data migration target based on a deletion deadline of the invalid data. Specifically, in this case, for example, the selection unit 42 selects the magnetic tape T1 in which the invalid data having a shortest remaining time until the deletion deadline is recorded. Thereby, the invalid data of which the deletion deadline arrives at the earliest is preferentially and physically deleted. Thus, it is possible to prevent the data of which the deletion deadline is passed from being accessed.

Further, in the embodiment, the calculation unit 40 may further calculate an index value V4 correlated with a data write frequency for each processing target magnetic tape. Examples of the index value V4 include the number of pieces of data of which the write frequency is equal to or higher than a threshold value TH4, a total value of sizes of the pieces of data of which the write frequency is equal to or higher than the threshold value TH4, and the like.

In this case, in a case where there are a plurality of magnetic tapes T1 of which the index values V1 are equal to or larger than the threshold value TH2 and a difference between the index values V1 of the plurality of magnetic tapes T1 is within a certain range, the selection unit 42 selects the magnetic tape T1 as a data migration target from among the plurality of magnetic tapes T1 based on the index value V4. Specifically, for example, the selection unit 42 selects, as a migration target, the magnetic tape T1 having a largest index value V4.

Further, in the embodiment, for example, as a hardware structure of a processing unit that executes various processing such as the calculation unit 40, the selection unit 42, and the controller 44, the following various processors may be used. The various processors include, as described above, a CPU, which is a general-purpose processor that functions as various processing units by executing software (program), and a dedicated electric circuit, which is a processor having a circuit configuration specifically designed to execute a specific processing, such as a programmable logic device (PLD) or an application specific integrated circuit (ASIC) that is a processor of which the circuit configuration may be changed after manufacturing such as a field programmable gate array (FPGA).

One processing unit may be configured by one of these various processors, or may be configured by a combination of two or more processors of the same type or different types (for example, a combination of a plurality of FPGAs or a combination of a CPU and an FPGA). Further, the plurality of processing units may be configured by one processor.

As an example in which the plurality of processing units are configured by one processor, firstly, as represented by a computer such as a client and a server, a form in which one processor is configured by a combination of one or more CPUs and software and the processor functions as the plurality of processing units may be adopted. Secondly, as represented by a system on chip (SoC) or the like, a form in which a processor that realizes the function of the entire system including the plurality of processing units by one integrated circuit (IC) chip is used may be adopted. As described above, the various processing units are configured by using one or more various processors as a hardware structure.

Further, as the hardware structure of the various processors, more specifically, an electric circuit (circuitry) in which circuit elements such as semiconductor elements are combined may be used.

Further, in the embodiment, an example in which the information processing program 30 is stored (installed) in the storage unit 22 in advance has been described. On the other hand, the present disclosure is not limited thereto. The information processing program 30 may be provided by being recorded in a recording medium such as a compact disc read only memory (CD-ROM), a digital versatile disc read only memory (DVD-ROM), or a Universal Serial Bus (USB) memory. Further, the information processing program 30 may be downloaded from an external device via a network.

What is claimed is:

1. An information processing apparatus comprising:
at least one processor,
wherein the processor is configured to
select a magnetic tape as a data migration target from among a plurality of migration-source magnetic tapes based on an index value correlated with a read frequency of valid data recorded in the magnetic tape, the index value being calculated for each of the magnetic tapes, and
specify valid data recorded in the selected magnetic tape and perform control of migrating the valid data to a migration-destination magnetic tape.

2. The information processing apparatus according to claim 1, wherein
the processor is configured to select, as the migration target, a magnetic tape of which the index value is equal to or larger than a threshold value or a magnetic tape of which the index value is relatively large.

3. The information processing apparatus according to claim 1, wherein
the processor is configured to select, as the migration target, a magnetic tape of which the index value is smaller than a second threshold value or a magnetic tape of which the index value is relatively small in a case where a value indicating a probability that data migration processing is to be interrupted is equal to or larger than a first threshold value.

4. The information processing apparatus according to claim 1, wherein
the processor is configured to perform control of migrating, among pieces of valid data and invalid data recorded in the selected magnetic tape, only the valid data to a migration-destination magnetic tape.

5. The information processing apparatus according to claim 4, wherein
the processor is configured to further select a magnetic tape as the migration target based on an index value correlated with an amount of the valid data or an index value correlated with an amount of the invalid data.

6. The information processing apparatus according to claim 4, wherein
the processor is configured to further select a magnetic tape as the migration target based on a deletion deadline of the invalid data.

7. The information processing apparatus according to claim 1, wherein
the processor is configured to further select a magnetic tape as the migration target based on an index value correlated with a data write frequency of each of the plurality of migration-source magnetic tapes.

8. The information processing apparatus according to claim 2, wherein
the processor is configured to perform control of migrating, among pieces of valid data and invalid data recorded in the selected magnetic tape, only the valid data to a migration-destination magnetic tape.

9. The information processing apparatus according to claim 3, wherein
the processor is configured to perform control of migrating, among pieces of valid data and invalid data recorded in the selected magnetic tape, only the valid data to a migration-destination magnetic tape.

10. The information processing apparatus according to claim 8, wherein
the processor is configured to further select a magnetic tape as the migration target based on an index value correlated with an amount of the valid data or an index value correlated with an amount of the invalid data.

11. The information processing apparatus according to claim 9, wherein
the processor is configured to further select a magnetic tape as the migration target based on an index value correlated with an amount of the valid data or an index value correlated with an amount of the invalid data.

12. The information processing apparatus according to claim 5, wherein
the processor is configured to further select a magnetic tape as the migration target based on a deletion deadline of the invalid data.

13. The information processing apparatus according to claim 8, wherein
the processor is configured to further select a magnetic tape as the migration target based on a deletion deadline of the invalid data.

14. The information processing apparatus according to claim 9, wherein
the processor is configured to further select a magnetic tape as the migration target based on a deletion deadline of the invalid data.

15. The information processing apparatus according to claim 10, wherein
the processor is configured to further select a magnetic tape as the migration target based on a deletion deadline of the invalid data.

16. The information processing apparatus according to claim 11, wherein
the processor is configured to further select a magnetic tape as the migration target based on a deletion deadline of the invalid data.

17. The information processing apparatus according to claim 2, wherein
the processor is configured to further select a magnetic tape as the migration target based on an index value correlated with a data write frequency of each of the plurality of migration-source magnetic tapes.

18. The information processing apparatus according to claim 3, wherein
the processor is configured to further select a magnetic tape as the migration target based on an index value correlated with a data write frequency of each of the plurality of migration-source magnetic tapes.

19. An information processing method executed by a processor of an information processing apparatus, the method comprising:
selecting a magnetic tape as a data migration target from among a plurality of migration-source magnetic tapes based on an index value correlated with a read frequency of valid data recorded in the magnetic tape, the index value being calculated for each of the magnetic tapes; and
specifying valid data recorded in the selected magnetic tape and performing control of migrating the valid data to a migration-destination magnetic tape.

20. A non-transitory computer-readable storage medium storing an information processing program causing a processor of an information processing apparatus to execute a process comprising:
selecting a magnetic tape as a data migration target from among a plurality of migration-source magnetic tapes based on an index value correlated with a read frequency of valid data recorded in the magnetic tape, the index value being calculated for each of the magnetic tapes; and
specifying valid data recorded in the selected magnetic tape and performing control of migrating the valid data to a migration-destination magnetic tape.
